(19) United States
(12) Patent Application Publication
(10) Pub. No.: US 2013/0086321 A1
(43) Pub. Date: Apr. 4, 2013

(54) FILE BASED CACHE LOADING

(71) Applicants: Robert E. Van Cleve, Houston, TX (US); Jeffrey A. Plank, Cypress, TX (US)

(72) Inventors: Robert E. Van Cleve, Houston, TX (US); Jeffrey A. Plank, Cypress, TX (US)

(21) Appl. No.: 13/702,759

(22) PCT Filed: Jul. 28, 2010
(86) PCT No.: PCT/US10/43472

§ 371 Date: Dec. 7, 2012

(51) Int. Cl. G06F 12/08

(52) U.S. Cl. CPC G06F 12/0802
USPC 711/118

(57) ABSTRACT

A method for loading a cache is disclosed. Data in a computer file is stored on a storage device. The computer file is associated with a computer program. The first step is to determine which logical memory blocks on the storage device correspond to the computer files (402). The next step is to take the data stored in the logical memory blocks and load it into a cache (404). The data is loaded into the cache before data from the file is requested by the computer programs.

### BACKGROUND

Read caches load blocks of data from slower storage devices like disk drives into higher speed storage devices like random access memory (RAM). Subsequent reads go directly to the higher speed devices thereby avoiding the latency due to the slower memory devices. Read caches algorithms can opportunistically load blocks of data that may be accessed in the future. By loading blocks of data from the slower storage device before the data is needed, the initial latency due to the slower storage device may be avoided. There may be multiple read caches in a system. One typical location for a read cache is on the storage controller for the slower memory devices.

One method read caches use to store blocks of data that may be used in the future is by selecting the next logical blocks of data stored after the block of data that was just requested. This technique is typically called a read-ahead algorithm. Unfortunately, the data used and stored by the most computer programs is organized by files and the data from a file may not be stored in contiguous memory blocks on the slower memory devices.

FIG. 1 is a block diagram of a segment of a file system 100 from a slower speed storage device. FIG. 1 shows a header block 102 followed by a plurality of logical storage blocks 1-N. The plurality of logical storage blocks 1-N may be along a single track of a disk drive, or may be distributed across a plurality of disk drives, for example in a RAID configuration. Each logical storage block can store the same amount of data, for example 512 Mbytes. In this example, data from two different files are stored in the logical memory blocks 1-N. File A requires three different memory blocks to be stored. File B can be stored using only two logical storage blocks. The first part of the data from file A is stored in logical storage block 1, the second part of the data from file A is stored in logical storage block 4, and the third part of the data from file A is stored in logical storage block 5. The first part of the data from file B is stored in logical storage block 2 and the second part of the data from file B is stored in logical storage block N. Logical storage block 3 is open and does not contain any data.

When a computer program needs the data stored in file A, the program “opens” file A by sending a request to the operating system. The operating system typically has a logical map between the name of the file (file A) and a local or address in memory space where the data is stored, as a well as the amount of data or length of the file. The operating system typically does the mapping between the file name and the locations in memory space where the data is stored. The operating system will send a request for data (a data read) to the storage controller using the mapped data location. The read request will typically have a starting location or address in memory space and a length. The operating system may break the request for data from the file into a number of different read request. In this example, the operating system may break the request into three different read requests. The first read request may correspond to the data stored in the first part of file A.

When the operating system sends the first read request, corresponding to the data stored in the first part of file A, to the storage controller, the storage controller may check its cache to determine if the data has been loaded into the cache. When the data has not been loaded into the cache, the storage controller will access the slower memory device and read block 1. The storage controller will return the data from block 1 to the operating system. The storage controller may also load the data from block 1 into its cache. If the cache in the storage controller is using a read ahead algorithm, the storage controller may also read the data from block 2 and load it into cache. In this example, reading the data from block 2 will not help reduce the latency due to the slower storage device. When the operating system requests the data from the next part of file A (the second part), the operating system will request the data from block 4. The data from block 2 that was loaded into the cache will not be used. Because the data from file A is not stored in contiguous logical storage blocks, the read ahead cache algorithm may no be effective in reducing the latency of the slower storage devices. The storage controller typically does not have any file level information that maps which blocks are assigned to which files.

### BRIEF DESCRIPTION OF THE DRAWINGS

FIG. 1 is a block diagram of a segment of a file system 100 from a slower speed storage device (Prior art).

FIG. 2 is a diagram of a computer system 200 in an example embodiment of the invention.

FIG. 3 is a block diagram of a storage blade 218 in an example embodiment of the invention.

FIG. 4 is a flow chart for a method of file based cache loading in an example embodiment of the invention.

### DETAILED DESCRIPTION

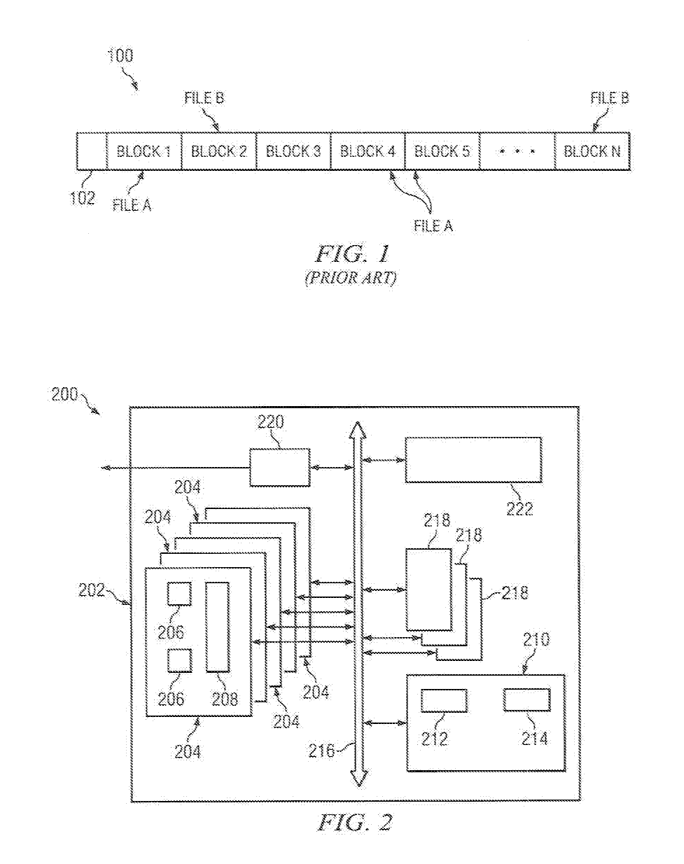

FIG. 1-4, and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 is a diagram of a computer system 200 in an example embodiment of the invention. Computer system 200 comprises rack 202, processor blades 204, controller 210, bus 216, I/O board 220, auxiliary blades 218, and power system 222. Processor blades 204, controller 210, I/O board 220, auxiliary blades 218, and power system 222 are mounted inside rack 202 and couple to bus 216. Bus 216 may be any type of communications bus or fabric, for example a PCIe bus. Processor blades 204 may comprise one or more processors 206 and memory 208. Auxiliary blades 218 may comprise memory blades, storage blades, additional I/O blades or the like. Controller 210 may comprise one or more processor 212 and memory 214. Controller 210 may be a baseboard management controller (BMC). Power system may comprise one or more power supplies and one or snore power controllers. Power system is also coupled to the different components with a power bus (not shown for clarity) that provides power from the power system to the other components. In one example embodiment of the invention, multiple computer systems 200 will be coupled together and operated as a group, for example in a data center.

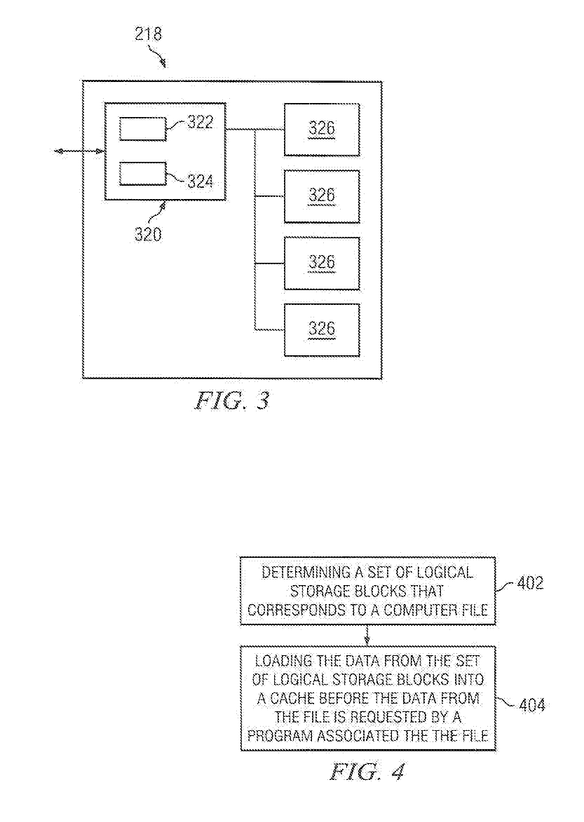

In operation, the processors 206 on the processor blades 204 may be executing code. The code may be a computer program. A computer program may be one or more operating systems, application programs, firmware routines, basic input output routines (BIOS), or the like. Controller 210 may be running code that monitors the operation of computer system 200 including the operations of the one or more operating systems and/or the operation of one or more of the auxiliary blades 218. In one example embodiment of the invention, one or more of the auxiliary blades 218 may be a storage blade. FIG. 3 is a block diagram of a storage blade 218 in an example embodiment of the invention.

Storage blade 218 comprises storage controller 320 and a plurality of storage devices 326. Storage devices may be hard disk drives, solid state drives, or the like. Storage controller 320 is coupled to, and controls, the plurality of storage devices 326. Storage controller 320 stores data onto storage devices 326 in logical storage blocks. Storage blade 218 is couples to bus 216 in computer system 200. Storage controller 320 comprises one or more processors 322 and cache 324. Storage controller 320 uses cache 324 to reduce the latency due to storage devices 326. In other example embodiments of the invention, the storage system may be external to computer system 200, for example a network attached storage system.

In one example embodiment of the invention, storage controller 320 loads the data from a plurality of logical memory blocks on the storage devices into cache 324. The logical storage blocks loaded into cache 324 correspond to one or more files stored onto the storage devices 326. The logical storage blocks loaded into the caches may not be from contiguous storage blocks because the data in the files may not be stored in contiguous memory blocks. Once the data is loaded into the cache, the data is marked as persistent. Data marked as persist remains “pinned” in the case until the persistent nature of the data is cleared. When a computer program, for example an application program or an operating system, requests the data saved in the file, the storage controller 320 can read the data directly from the read cache 324 versus the storage devices and immediately return the data to the requesting program.

The file(s) may be associated with a particular application program or an instantiation of an operating system. In one example embodiment of the invention, the files used or associated with a computer program are identified. Once the files are identified, the logical storage blocks corresponding to the files are identified. When the program is launched or instantiated, the data contained in the logical storage blocks are loaded into a cache. When the program opens its associated files, the data from the files will already be loaded into the cache, thereby reducing the access time for the data.

In some example embodiments of the invention, the files used or associated with a program may depend on who launched the program. For example, when the program is a web based program used by a plurality of users, each instantiation of the program may be associated with a different set of files. For example, a first user may have a first set of images, songs, or data, stored in files accessed by the program, and a second user may have a second set of images, songs or data accessed by the same program when launched by the second user. In one example embodiment of the invention, the storage blocks loaded into the cache may correspond to the files associated with an instantiation of the program that corresponds to a specific user ID. In other example embodiments of the invention, the files associated with the program may not be dependent on the user of the program.

The files associated with a program or an operating systems can be determined in a number of different ways. In one example embodiment of the invention, an administrator may make a list of files used by a program. In another example embodiment of the invention, the operating system may keep track of the files used by different programs. The operating system may keep track of the files used by a program for each different user that launches the program. In yet another example embodiment of the invention, a tracking program, running on controller 210, may track which files are associated with each program or operating system running on one or more of the processor blades 204. The tracking program may be started before the program to be tracked is launched, and stopped after the program to be tracked is ended. Once the list of files associated with a program have been determined, the logical storage blocks associated with the files is determined.

Determining the logical storage blocks associated with a file can be done in a number of ways. In one example embodiment of the invention, a file walking program can be used. The file walking program takes the list of files and “touches” or accesses each file. The file walking program tracks which logical blocks in the storage devices are accessed as it reads or touches each of the files. In this way the file walking program generates a list of logical storage blocks that corresponds to each of the files associated with a program. In another example embodiment of the invention, the tracking program, running on controller 210, may directly track which logical storage blocks are associated with each program, instead of tracking which files are associated with each program. In another example embodiment of the invention, the storage controller may track the logical memory blocks used after receiving a “start tracking” command. The storage controller would stop tracking which logical blocks were loaded after receiving a “stop tracking” command. The list of logical memory block associated with a file or a program can be stored for later use.

Once the list of logical blocks associated with a file or a program have been determined, the data stored in the list of logical blocks can be read from the logical storage blocks and moved into cache. The data can be moved into cache using a number of different triggers. In one example embodiment of the invention, the trigger to move the data into cache can be a user or administrator command. Once the data has been loaded into cache the data may be marked as persistent. A second user or administrator command may be used to clear the persistent property of the data so that the data may be flushed from cache using the normal cache algorithm. There may be a third command that immediately flushes the data from cache. In some embodiments the second and third commands may be combined.

In another example embodiment of the invention, the trigger to load the data into cache may be when the program is launched or instantiated. When the logical storage blocks are associated with a program launched by a specific user, only the data from the logical storage blocks that are associated with that user are loaded into cache when the user launches the program. The trigger to flush the cache may be when the program is closed or ends.

FIG. 4 is a flow chart for a method of file based cache loading in an example embodiment of the invention. The method relates to moving the data stored as a file on a storage device into a cache. The data in the file is stored on the storage devices as a plurality of logical storage blocks. Flow starts at step 402 where the set of logical storage blocks that correspond to a file are determined. At step 404, the data from the set of logical storage blocks is read from the storage devices and loaded into a cache. The data from the logical storage blocks is moved into the cache before a program associated with the file requests the data from the file.

1. A. method for loading a cache, comprising:
determining a plurality of logical memory blocks that correspond to at least one computer file (402), wherein data in the at least one computer file is stored on a first storage device in the plurality of logical memory blocks, wherein the at least one computer file is associated with a first instantiation of a computer program;
loading the data from the plurality of logical memory blocks from the first storage device into a cache before data from the file is requested by the first instantiation of the computer program (404).

2. The method for loading a cache of claim 1, further comprising:
marking the data loaded into the cache as persistent.

3. The method for loading a cache of claim 1, wherein the data is loaded into cache when the first instantiation of the computer program is launched.

4. The method for loading a cache of claims 3, wherein the data is flushed from the cache when the first instantiation of the computer program is closed.

5. The method for loading a cache of claim 1, wherein the computer program is selected from the group consisting of: an operating system, an application program

6. The method for loading a cache of claim 1, wherein the determining of the at least one computer file associated with the computer program is done during a tracking period.

7. The method for loading a cache of claim 1, further comprising:
determining a second plurality of logical memory blocks that correspond to a second computer file, wherein data in the second computer file is stored on the first storage device and the second computer file is associated with a second instantiation of the computer program;
loading the data from the second plurality of logical memory blocks into the cache before data from the second file is requested by the second instantiation of the computer program.

8. The method for loading a cache of claim 7, wherein the first instantiation of the computer program is launched using a first user ID and the second instantiation of the computer program is launched using a second, different, user ID.

9. A computer system, comprising:
a storage controller (320), the storage controller having a cache (324);
a plurality of storage devices (326) coupled to, and controlled by, the storage controller (320);
the storage controller (320) configured to load data from a plurality of logical storage blocks stored on the plurality of storage devices (326) into the cache (324) on the occurrence of a single event, wherein the plurality of logical storage blocks correspond to a plurality of computer files.

10. The computer system of claim 9, wherein the occurrence of the single event is selected from the group consisting of: a command, the launching of a program associated with the plurality of files.

11. The computer system of claim 9, wherein the data loaded into the cache (324) is marked as persistent.

12. The computer system of claim 9, further comprising:
wherein the occurrence of the single event is when a first user launches a program associated with the plurality of computer files;
the storage controller (320) loading data from a second plurality of logical storage blocks stored on the plurality of storage devices (326) into the cache (324) on the occurrence of a second single event, wherein the second plurality of logical storage blocks correspond to a second plurality of computer files and where the second plurality of computer files are associated with the program when the program is launched by a second user, different than the first user.

13. The computer system of claims 9, further comprising:
a controller (210) coupled to the storage controller (320), the controller (210) sending a list of the plurality of logical storage blocks to the storage controller (320) on the occurrence of the single event.
